(19) United States
(12) Patent Application Publication
(10) Pub. No.: US 2011/0084968 A1
(43) Pub. Date: Apr. 14, 2011

(54) IMAGE DRAWING APPARATUS, IMAGE DRAWING METHOD, AND STORAGE MEDIUM

(75) Inventor: Hiroyuki Akai, Kawasaki-shi (JP)

(73) Assignee: CANON KABUSHIKI KAISHA, Tokyo (JP)

(21) Appl. No.: 12/896,683

(22) Filed: Oct. 1, 2010

(30) Foreign Application Priority Data
Oct. 8, 2009 (JP) 2009-234394

(51) Int. Cl. G06T 11/20

(52) U.S. Cl. 345/442

(57) ABSTRACT

A division number that defines the number of divided straight lines representing a circular graphic pattern is registered beforehand in a division number table in relation to a radius r of the circular graphic pattern. Further, data usable to calculate X-coordinate and Y-coordinate values of endpoints of respective divided straight lines are registered beforehand in an endpoint table in relation to a straight line division number N. Accordingly, if a graphic pattern to be drawn is a circular graphic pattern, it is unnecessary to approximate an outline (curve) with Bezier curves and each division point (endpoint) of divided straight lines can be directly and quickly obtained using the trigonometric function.

### BACKGROUND OF THE INVENTION

1. Field of the Invention

The present invention relates to an image drawing apparatus, an image drawing method, and a computer-readable storage medium. More specifically, the present invention relates to a technique capable of drawing a part or the whole of a circle.

2. Description of the Related Art

The display of graphic data described in a vector format on a display device requires rendering processing to convert given vector data into “coordinate data defined by the display device” that can be calculated based on logical data and to perform drawing. There are conventional methods capable of improving efficiency in processing of vector data (each graphic data).

A conventional method discussed in Japanese Patent Application Laid-Open No. 8-297747 includes smoothly drawing a curve by changing a division interval of a curve including a circle based on an area of the curve. Further, a conventional method discussed in Japanese Patent Application Laid-Open No. 10-11592 includes selecting optimum processing for drawing a line segment with reference to drawing attributes, such as a line width, an inclination, and a shape, of each line segment so as to improve the efficiency in the rendering processing.

When focusing on the drawing of a perfect circle (hereinafter, referred to as “circular graphic pattern”), to draw the circular graphic pattern defined by vector data on a display device, a conventional method includes first approximating the circular graphic pattern with curve vectors such as Bezier curves. The conventional method further includes calculating an approximation number (division number) of the curve vectors based on a radius of the circular graphic pattern. As discussed in Japanese Patent Application Laid-Open No. 7-168945, the conventional method includes obtaining control points to draw each curve according to a calculated division number (division point) and dividing the circular graphic pattern into a combination of curve vector data. Further, as discussed in Japanese Patent Application Laid-Open No. 11-58871, the conventional method includes dividing the curve vector data of each curve into a plurality of pieces of straight line vector data.

However, according to the above-described conventional methods, the curve division processing and the straight line division processing are unconditionally performed regardless of a size of a circular graphic pattern to be drawn. Therefore, for example, if the size of a circular graphic pattern (i.e., a drawing object) is small, a divided curve is divided (approximated) into a single straight line through the straight line division processing. As a result, control points of Bezier curves and calculation processing become redundant.

Further, when the drawing of a plurality of circular graphic patterns is designated, an amount of processing load tends to become larger because the processing is repetitively performed.

Further, the above-described conventional methods perform calculation of coordinate values of each straight line divided from a circular graphic pattern for each raster. Therefore, the amount of processing load tends to become larger when the drawing of numerous circular graphic patterns is designated, for example, when a circle is designated as an interpolated graphic pattern in line join processing or in line cap processing.

### SUMMARY OF THE INVENTION

According to an aspect of the present invention, an apparatus which divides vector data representing a circle into a plurality of straight lines and rasterizes a part or a whole of the circle based on the divided plurality of straight lines includes a first calculation unit configured to calculate a division number N of the circle referring to a first storage area in which information relating to the division number is registered in advance with respect to information relating to a size of the circle, a second calculation unit configured to calculate endpoint positions of the plurality of straight lines by using the calculated division number referring to a second storage area in which information relating to the endpoint positions is registered in advance with respect to the information relating to the division number, and a drawing unit configured to rasterize the part or the whole of the circle by using a third calculation unit configured to calculate a rasterization pattern representing a drawing content of a finite number of straight lines having endpoints at the calculated positions referring to a third storage area in which information relating to the rasterization pattern representing the straight lines is registered in advance with respect to information relating to a relative positional relationship between both endpoints of the straight lines.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an information processing apparatus according to an exemplary embodiment of the present invention.

FIG. 2 illustrates an example of a division number table.

FIG. 3A illustrates an example of endpoints of straight lines in a case where a circular graphic pattern is divided into a plurality of straight lines, and FIG. 3B illustrates an example of an endpoint table.

FIG. 4 illustrates an example of a method for obtaining rasterization data.

FIG. 5 is a flowchart illustrating an example procedure of processing for generating rasterization data.

FIG. 6 is a flowchart illustrating details of a part of the flowchart illustrated in FIG. 5.

FIG. 7 is a flowchart illustrating details of a part of the flowchart illustrated in FIG. 5, which follows step S17 illustrated in FIG. 6.

FIG. 8 is a flowchart illustrating details of a part of the flowchart illustrated in FIG. 5, which follows step S12 illustrated in FIG. 6.

FIG. 9 is a flowchart illustrating details of a part of the flowchart illustrated in FIG. 5, which follows step S30 illustrated in FIG. 8.

FIG. 10A illustrates an example of line join processing, and FIG. 10B illustrates an example of line cap processing.

FIG. 11A illustrates an example of a broken line portion forming a gap, and FIG. 11B illustrates an example of endpoints of a circular graphic pattern to be used to interpolate the gap.

FIG. 12 is a flowchart illustrating an example of straight line division processing according to an exemplary embodiment of the present invention.

### DESCRIPTION OF THE EMBODIMENTS

Various exemplary embodiments, features, and aspects of the invention will be described in detail below with reference to the drawings.

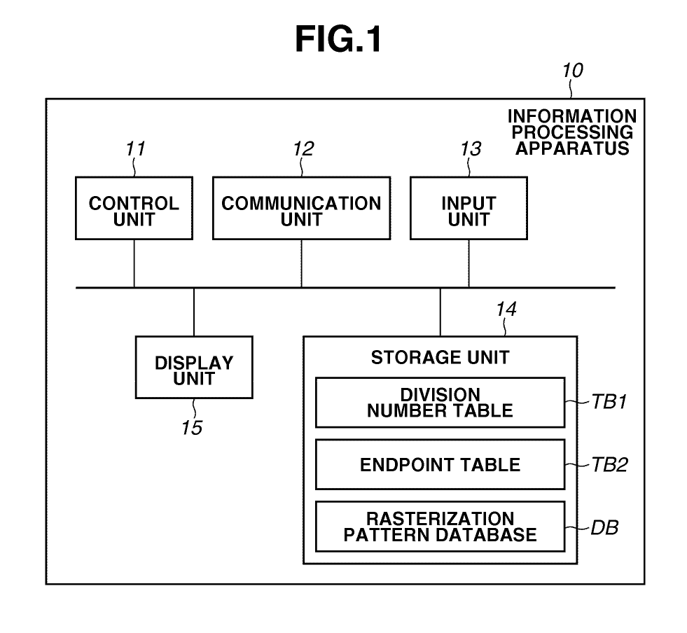

A first exemplary embodiment of the present invention is described below. FIG. 1 is a block diagram illustrating a configuration of an information processing apparatus 10. The information processing apparatus 10 includes a control unit 11, a communication unit 12, an input unit 13, a storage unit 14, and a display unit 15.

The control unit 11 is, for example, constituted by a central processing unit (CPU) and can control various operations of the information processing apparatus 10. The communication unit 12 is, for example, constituted by a communication interface and can communicate with an external device. The input unit 13 is, for example, constituted by a keyboard and a mouse and can receive an operational instruction input by a user for the information processing apparatus 10.

The storage unit 14 is, for example, constituted by a read only memory (ROM), a random access memory (RAM), and a hard disk drive (HDD). The storage unit 14 stores data and computer programs for the information processing apparatus 10. In the present exemplary embodiment, the data set (or stored) beforehand in the storage unit 14 includes a division number table TB1, an endpoint table TB2, and a rasterization pattern database DB. Further, a maximum division radius Rd, a maximum division number M, and a maximum rasterization radius Rr are also set (stored) in the storage unit 14.

However, at least one of the division number table TB1, the endpoint table TB2, the rasterization pattern database DB, the maximum division radius Rd, the maximum division number M, and the maximum rasterization radius Rr can be stored in an external device that can communicate with the information processing apparatus 10. Further, values of the above-described parameters are variable depending on an actually embodied system, environmental conditions, or processing performances of the system.

Hereinafter, the above-described parameters are described in more detail. The maximum division radius Rd and the maximum division number M (M is an integer equal to or greater than 2) are maximum values of a maximum circle radius and a division number that can be set to the division number table TB1 and the endpoint table TB2, which are described below, respectively. For example, when a radius r of a circular graphic pattern (perfect circle) to be drawn exceeds a maximum circle radius Rd, according to the present exemplary embodiment, it is determined that rendering processing using the division number table TB1, the endpoint table TB2, and the rasterization pattern database DB is unfeasible for the circular graphic pattern to be drawn. In this case, conventional processing for dividing the circular graphic pattern to be drawn into Bezier curves is selected according to the present exemplary embodiment.

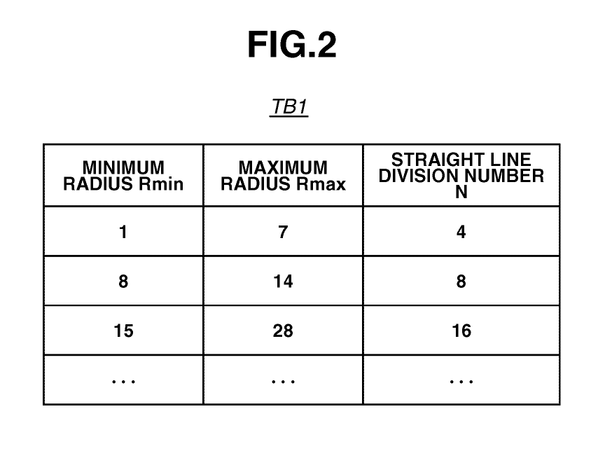

FIG. 2 illustrates an example of the division number table TB1. The division number table TB1 is a table usable to obtain a straight line division number N (N is an integer equal to or greater than 2) of a circle based on the radius r of a given circular graphic pattern. As illustrated in FIG. 2, the division number table TB1 includes the straight line division number N, a maximum radius Rmax of the circle having the straight line division number N, and a minimum radius Rmin of the circle, as constituent elements. The straight line division number N included in the division number table TB1 includes the radius r of the given circular graphic pattern that is not smaller than the minimum radius Rmin and not greater than the maximum radius Rmax. In this case, it is desired that each straight line division number N in the division number table TB1 is a common divisor of the maximum division number M so that the endpoint table TB2 described below can be efficiently used.

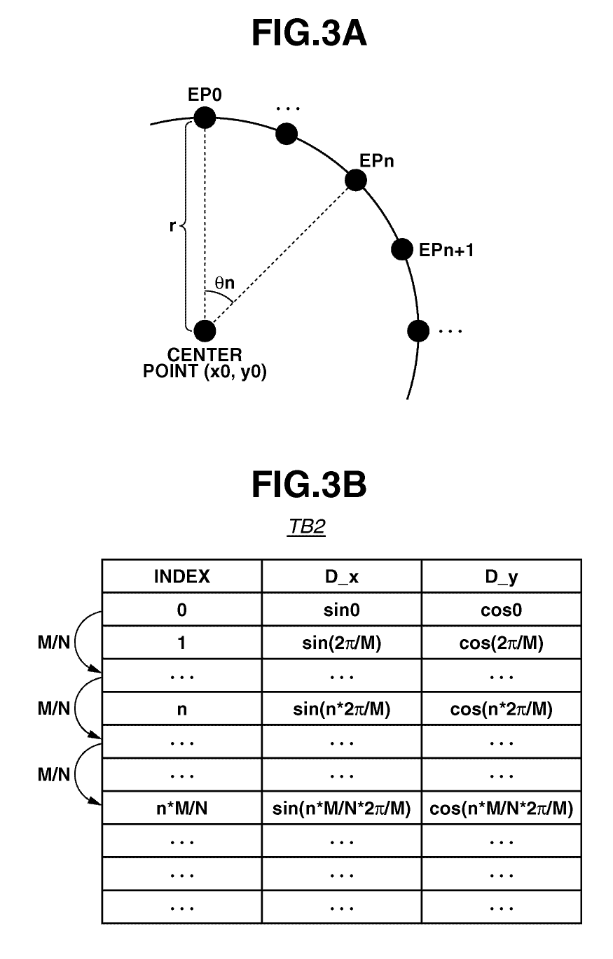

FIG. 3A illustrates an example of endpoints of straight lines in a case where a circular graphic pattern is divided into a plurality of straight lines. FIG. 3B illustrates an example of the endpoint table TB2.

The endpoint table TB2 is a table storing coordinate values of endpoints of respective straight lines (line segments) beforehand, which is usable in processing for dividing a circular graphic pattern into a plurality of straight lines. The coordinate values of endpoints of respective straight lines can be obtained by performing calculations using the trigonometric function. In general, in a case where a line segment is divided into N straight line parts, each endpoint EPn (xn, yn), in which n=0, 1, . . . , N−1, can be obtained by using the trigonometric function as illustrated in FIG. 3A, based on coordinate values (xo, yo) of a central point of the circle, the radius r of the circle, and an angle θn [rad] relative to a reference point EP0.

The angle θn relative to the reference point EP0 is an angle defined between a straight line connecting the central point and the reference point EP0 and a straight line connecting the central point and an endpoint EPn. The angle θn relative to reference point EP0 can be obtained, if a division number of the circle is determined, by setting the reference point EP0 to 0 (zero) and using an endpoint number n that identifies an endpoint of each of N divided line segments. Further, a result of trigonometric function calculation using the above-described values can be stored beforehand as a table.

In the present exemplary embodiment as illustrated in FIG. 3B, the endpoint table TB2 includes the endpoint number n (division number) from the reference point EP0 as an index and stores coordinate data D_x and D_y that are usable to calculate X-coordinate and Y-coordinate values of an endpoint represented by the endpoint number n.

In this case, there is no need to prepare a plurality of the endpoint tables TB2 for each radius r of the circular graphic pattern or each straight line division number N. In other words, a single endpoint table TB2 which is prepared beforehand for the maximum division number M can be commonly used to obtain X-coordinate and Y-coordinate values of endpoints of line segments divided according to the different straight line division number N. For an example method, a reference interval M/N of the endpoint table TB2 is obtained with reference to the desired straight line division number N for the circular graphic pattern and the maximum division number M. Further, coordinate values of an endpoint represented by the endpoint number n can be obtained by acquiring stored data from the endpoint table TB2 referring to an index n*M/N (see the left edge in FIG. 3B).

The above-described method can obtain coordinate values of each endpoint of line segments divided into N straight line parts using only the single endpoint table TB2 regardless of the straight line division number N. Accordingly, it is not necessary to store redundant information using a plurality of tables. As a result, efficient storage of data can be realized. The division number (circle radius) settable for the straight line division processing is dependent on the division number of the endpoint table TB2. Therefore, it is desired to set the division number (the maximum division number M) of the endpoint table TB2 to be as large value as possible. As described above, M indices are present in the endpoint table TB2 according to the present exemplary embodiment.

The following formulae (1) to (3) can be used to calculate an X-coordinate value xn and a Y-coordinate value yn of the endpoint EPn of each divided line segment and the angle θn relative to the reference point EP0. Further, the following formulae (4) and (5) can be used to calculate an X-coordinate value xn and a Y-coordinate value yn of the endpoint EPn which are obtainable from the endpoint table TB2, respectively.

Xn=xo+r*sin(θn) (1)

Yn=yo−r*cos(θn) (2)

θn=n*2π/N (3)

Xn=xo+r*TB2[n*M/N,1] (4)

Yn=yo−r*TB2[n*M/N,2] (5)

In the above-described formulae, TB2 [n*M/N, 1] represents a D_x value corresponding to the index n*M/N in the endpoint table TB2. TB2 [n*M/N, 2] represents a D_y value corresponding to the index n*M/N in the endpoint table TB2.

The maximum rasterization radius Rr is a maximum radius of the circular graphic pattern which is settable according to the method using the rasterization pattern database DB described below in the rasterization of each divided line segment. The rasterization pattern database DB is a database that stores pieces of rasterization data representing drawing contents of divided line segments.

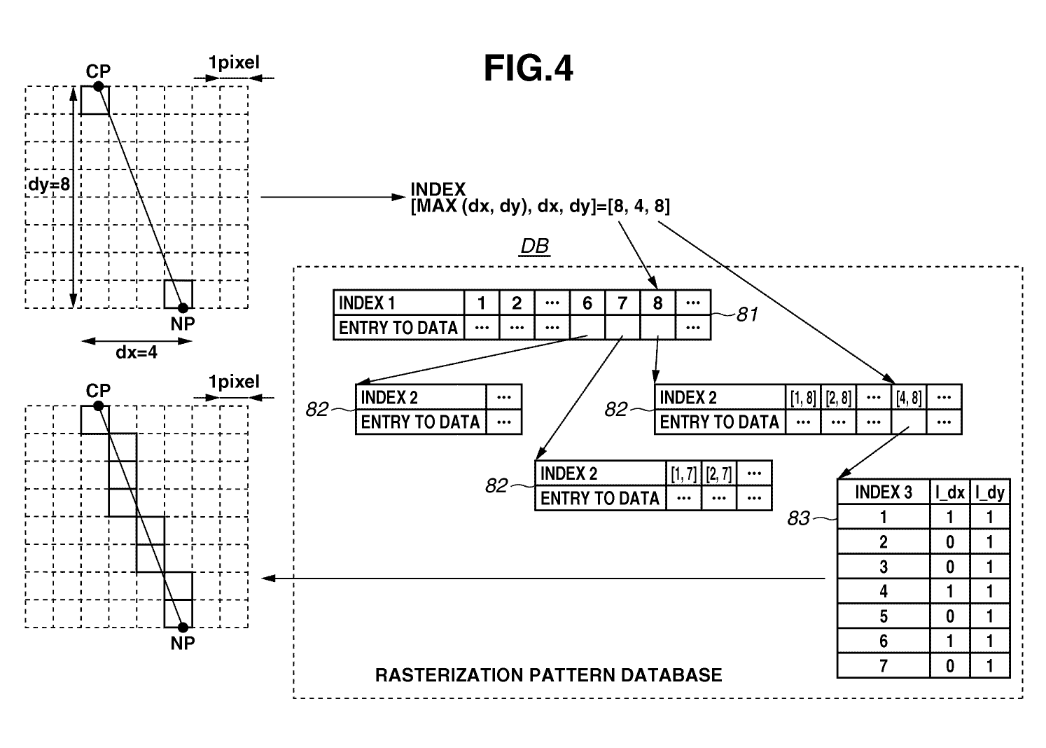

FIG. 4 illustrates an example of a method for obtaining rasterization data that can be derived from divided line segments using the rasterization pattern database DB.

As illustrated in FIG. 4, the rasterization pattern database DB includes indices of a difference (dx, dy) between coordinate values of both endpoints which are rounded to integers and a maximum value MAX (dx, dy) of the difference which can represent a relative positional relationship between a start position CP and an end position NP (both endpoints). Further, the rasterization pattern database DB stores, for example, variations (l_dx, l_dy) relative to an immediately preceding raster in the X direction and the Y direction as rasterization pattern data of each divided line segment.

According to the example illustrated in FIG. 4, a data block 81 includes an index 1 representing the maximum value MAX (dx, dy) of the difference obtainable when the coordinate values of both endpoints are rounded to integers. The data block 81 further includes an entry to a data block 82 that classifies and stores rasterization pattern data for each size. The data block 82 includes an index 2 representing the difference [dx, dy] between both endpoints of each line segment for each size. The data block 82 further includes an entry to each rasterization pattern data block 83. Each of the rasterization pattern data block 83 includes an index 3 representing a number allocated in relation to a start point of a line segment. The rasterization pattern data block 83 stores variations l_dx in the X direction and l_dy in the Y direction relative to coordinate values of an immediately preceding raster.

In this case, a line segment divided from a circular graphic pattern is limited in length and inclination. Accordingly, it is not necessary to prepare a database storing all rasterization patterns of line segments as the rasterization pattern data 83. Storing only the required rasterization pattern data in this manner is effective to reduce an amount of data to be stored and improve the processing efficiency.

At least one of the endpoint table TB2 and the rasterization pattern database DB is not required to store all pieces of data in the entire circumferential direction (i.e., data corresponding to the whole of a perfect circle). Taking symmetry of a circle into consideration, it is useful to store only the data corresponding to apart of the perfect circle (e.g., data corresponding to only one quadrant (¼ of the entire circumference)). Further, to reduce the amount of data to be stored and improve the efficiency in processing, it is useful to perform the processing for switching the sign or XY values when calculation of coordinate values of an endpoint in a different quadrant (an endpoint corresponding to another portion of the perfect circle) is performed or when rasterization of a line segment in a different quadrant (i.e., a line segment corresponding to another portion of the perfect circle) is performed.

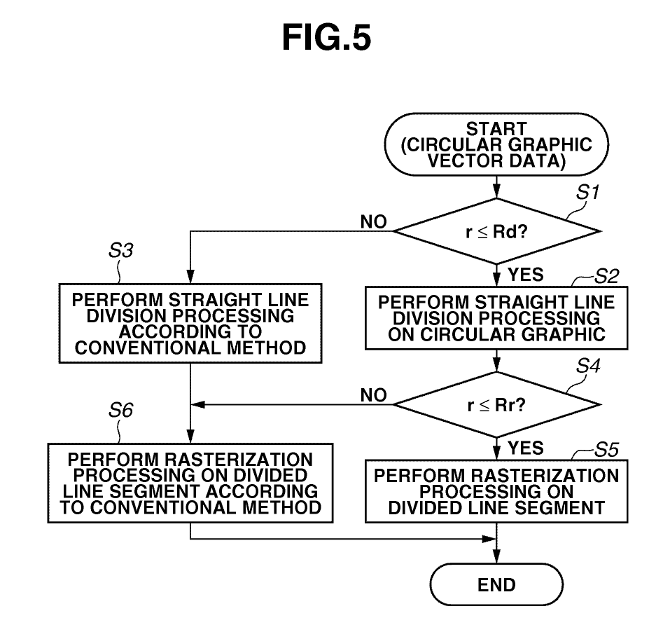

FIG. 5 is a flowchart illustrating an example procedure of processing that can be performed by the information processing apparatus 10 in generation of rasterization data from vector data of a circular graphic pattern.

If drawing of vector data representing a circular graphic pattern is designated, then in step S1, the control unit 11 determines whether the radius r of the circular graphic pattern (i.e., the drawing object) is equal to or less than the maximum division radius Rd. As a result of the above-described determination, if it is determined that the radius r of the designated circular graphic pattern is equal to or less than the maximum division radius Rd (YES in step S1), the processing of the control unit 11 proceeds to step S2. In step S2, the control unit 11 performs straight line division processing on the circular graphic pattern with reference to the division number table TB1 and the endpoint table TB2. The straight line division processing on the circular graphic pattern will be described in detail below.

On the other hand, if it is determined that the radius r of the designated circular graphic pattern is greater than the maximum division radius Rd (NO in step S1), the processing of the control unit 11 proceeds to step S3. In step S3, the control unit 11 performs straight line division processing according to a conventional method which is characteristic in that curve division processing is performed before starting the straight line division processing. The curve division processing will be described in detail below.

If the processing in step S2 is completed, then in step S4, the control unit 11 determines whether the radius r of the circular graphic pattern is equal to or less than the maximum rasterization radius Rr. As a result of the above-described determination, if it is determined that the radius r of the circular graphic pattern is equal to or less than the maximum rasterization radius Rr (YES in step S4), the processing of the control unit 11 proceeds to step S5. In step S5, the control unit 11 performs rasterization processing on a divided line segment using a rasterization data pattern database DB.

As a determination result in step S4, if it is determined that the radius r of the circular graphic pattern is greater than the maximum rasterization radius Rr (NO in step S4), or if the processing in step S3 is completed, the processing of the control unit 11 proceeds to step S6. In step S6, the control unit 11 performs rasterization processing according to a conventional method which is characterized in that calculation of coordinate values of each line segment on the display device is performed in units of a raster.

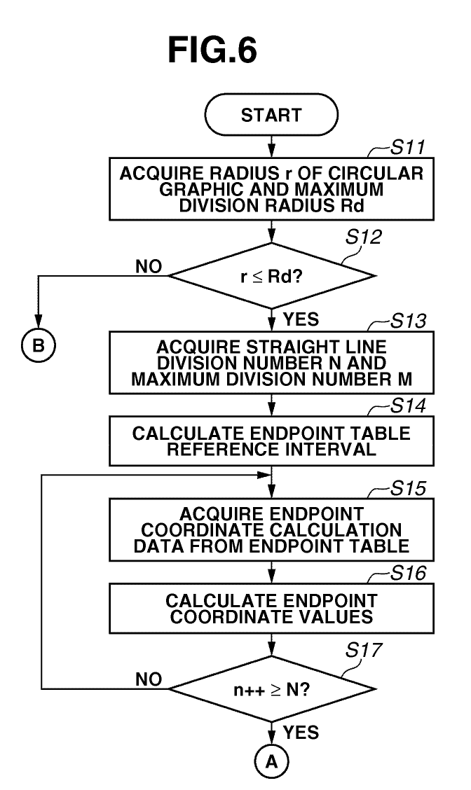

Next, the processing illustrated in the flowchart in FIG. 5 is described in more detail with reference to flowcharts illustrated in FIGS. 6 to 9.

First, if drawing of the vector data representing the circular graphic pattern is designated, then in step S11 illustrated in FIG. 6, the control unit 11 acquires the radius r of the circular graphic pattern (i.e., the drawing object) and the maximum division radius Rd.

Next, in step S12, the control unit 11 determines whether the radius r of the circular graphic pattern (i.e., the drawing object) is equal to or less than the maximum division radius Rd. As a result of the above-described determination, if it is determined that the radius r of the circular graphic pattern (i.e., the drawing object) is equal to or less than the maximum division radius Rd (YES in step S12), the control unit 11 determines that the calculation of coordinate values of each endpoint using the division number table TB1 and the endpoint table TB2 is feasible. The processing of the control unit 11 proceeds to step S13.

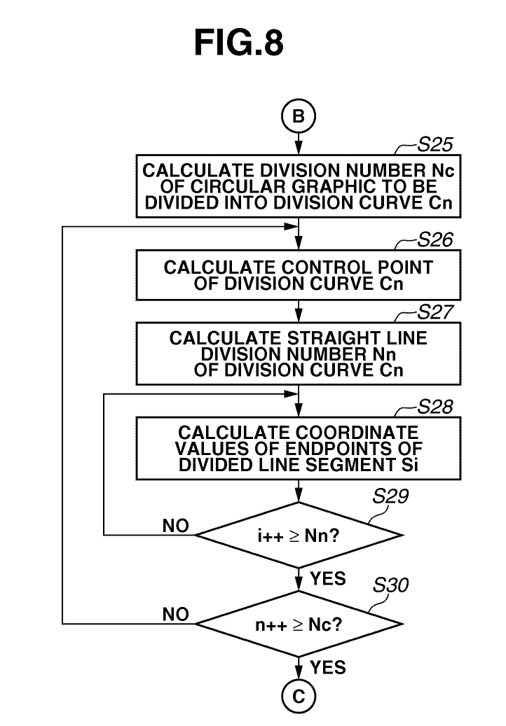

On the other hand, if it is determined that the radius r of the circular graphic pattern (i.e., the drawing object) is greater than the maximum division radius Rd (NO in step S12), the control unit 11 determines that the calculation of coordinate values of each endpoint using the division number table TB1 and the endpoint table TB2 is unfeasible. The processing of the control unit 11 proceeds to step S25 illustrated in FIG. 8. As described below, in step S25 and subsequent steps, the control unit 11 performs the straight line division processing according to the conventional method which is characterized in that the circular graphic pattern is divided into a plurality of curve vectors and then the straight line division processing is performed.

When the processing proceeds to step S13, the control unit 11 directly acquires a straight line division number N for the circular graphic pattern (i.e., the drawing object) from the division number table TB1 with reference to the radius r of the circular graphic pattern (i.e., the drawing object). Then, the control unit 11 acquires a maximum division number M.

As described above, an example of a first calculation unit according to the present exemplary embodiment can be realized, for example, by executing the processing in step S13. An example of a first storage area can be realized by using the division number table TB1.

Next, in step S14, the control unit 11 calculates a reference interval M/N that enables data reference corresponding to the desired straight line division number N based on the single endpoint table TB2 generated for the maximum division number M.

Next, in step S15, the control unit 11 acquires data D_x and D_y that are usable to calculate coordinate values of a desired endpoint corresponding to the reference index n*M/N in the endpoint table TB2, based on the endpoint number n (n=0, 1, . . . , N−1) and the reference interval M/N.

Next, in step S16, the control unit 11 performs calculation according to the above-described formulae (4) and (5) to obtain coordinate values (xn, yn) of the endpoint EPn based on the coordinate calculation data D_x and D_y acquired in step S15. In this case, the data stored in the endpoint table TB2 is data for the first quadrant. In a case where a desired data is an endpoint in the fourth quadrant, the control unit 11 inverses the sign of the data D_y to be used to calculate a Y-coordinate value of the endpoint. As described above, the control unit 11 includes a unit configured to adapt coordinate calculation data of the endpoint table TB2 of a different quadrant to coordinate calculation data of a desired endpoint.

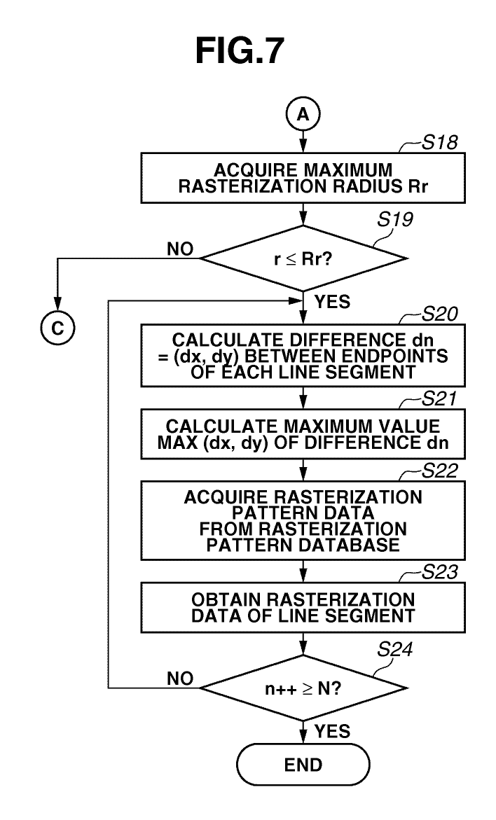

Next, in step S17, the control unit 11 determines whether an incremented endpoint number (=present endpoint number n+1) is equal to or greater than the straight line division number N of the circular graphic pattern (i.e., the drawing object). As a result of the above-described determination, if it is determined that the incremented endpoint number (=present endpoint number n+1) is less than the straight line division number N of the circular graphic pattern (i.e., the drawing object) (NO in step S17), the processing returns to step S15. The control unit 11 updates the present endpoint number n by the incremented endpoint number (=present endpoint number n+1) and executes the processing in step S15 with respect to the updated endpoint number n. If the above-described coordinate calculation is completed for all of N endpoints, the processing of the control unit 11 proceeds to step S18 illustrated in FIG. 7.

As described above, an example of a second calculation unit according to the present exemplary embodiment can be realized, for example, by executing the processing in steps S14 to S17. Further, an example of a second storage area can be realized by using the endpoint table TB2.

When the processing proceeds to step S18 illustrated in FIG. 7, the control unit 11 acquires the maximum rasterization radius Rr.

Next, in step S19, the control unit 11 determines whether the radius r of the circular graphic pattern (i.e., the drawing object) is equal to or less than the maximum rasterization radius Rr. As a result of the above-described determination, if it is determined that the radius r of the circular graphic pattern (i.e., the drawing object) is equal to or less than the maximum rasterization radius Rr (YES in step S19), the control unit 11 determines that rasterization processing using the rasterization pattern database DB is feasible. The processing of the control unit 11 proceeds to step S20.

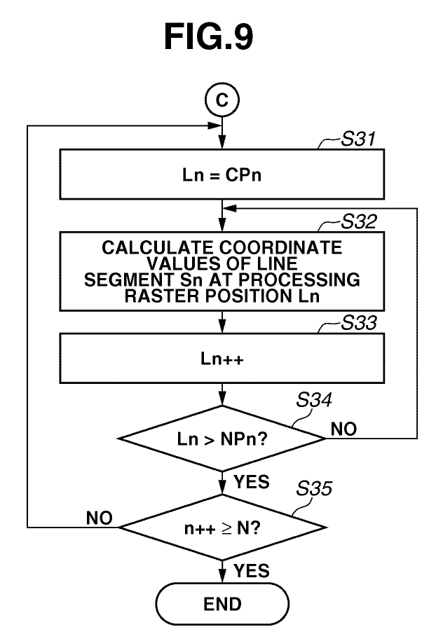

On the other hand, if it is determined that the radius r of the circular graphic pattern (i.e., the drawing object) is greater than the maximum rasterization radius Rr (NO in step S19), the processing of the control unit 11 proceeds to step S31 illustrated in FIG. 9. In step S31, as described below, the control unit 11 performs rasterization processing according to the conventional method which is characterized in that calculation of coordinate values of each line segment on the display device is performed in units of a raster.

When the processing proceeds to step S20, the control unit 11 rounds up coordinate values representing both endpoints of each of a plurality of divided line segments to integers and calculates a difference dn=(dx, dy) between the coordinate values of endpoints of each divided line segment (see FIG. 4).

In step S21, the control unit 11 calculates a maximum value MAX (dx, dy) of the difference dn calculated in step S20.

In step S22, the control unit 11 acquires rasterization pattern data of a desired line segment from the rasterization pattern database DB with indices of the difference dn and the maximum value MAX (dx, dy) of the difference dn.

In step S23, the control unit 11 quickly obtains coordinate values of a line segment on the display device by successively adding the rasterization pattern data acquired in step S22 to the start point CP of the line segment.

Next, in step S24, the control unit 11 determines whether an incremented endpoint number (=present endpoint number n+1) is equal to or greater than the straight line division number N of the circular graphic pattern (i.e., the drawing object). As a result of the above-described determination, if it is determined that the incremented endpoint number (=present endpoint number n+1) is less than the straight line division number N of the circular graphic pattern (i.e., the drawing object) (NO in step S24), the processing returns to step S20. The control unit 11 updates the present endpoint number n by the incremented endpoint number (=present endpoint number n+1) and executes the processing in step S20 with respect to the updated endpoint number n. If the above-described rasterization data acquisition for all of N line segments (rasterization of the circular graphic pattern) is completed, namely, if it is determined that the incremented endpoint number (=present endpoint number n+1) is equal to or greater than the straight line division number N of the circular graphic pattern (i.e., the drawing object) (YES in step S24), the control unit 11 terminates the processing of the flowchart illustrated in FIG. 7.

As described above, an example of a third calculation unit according to the present exemplary embodiment can be realized, for example, by executing the processing in steps S20 to S24. Further, an example of a third storage area can be realized by using the rasterization pattern database DB.

As described above, in step S12 illustrated in FIG. 6, if it is determined that the radius r of the circular graphic pattern (i.e., the drawing object) is greater than the maximum division radius Rd (NO in step S12), the control unit 11 determines that the calculation of coordinate values of each endpoint using the division number table TB1 and the endpoint table TB2 is unfeasible. The processing of the control unit 11 proceeds to step S25 illustrated in FIG. 8.

When the processing proceeds to step S25, the control unit 11 calculates a division number Nc of the circular graphic pattern to be divided into Bezier curves (hereinafter, referred to as “division curve Cn” if appropriate) as a single curve that is present in one quadrant.

Next, in step S26, the control unit 11 calculates control points including the start point and the end point of the division curve Cn (n=1, 2, . . . , Nc). A method for calculating the control points is conventionally known, for example, as discussed in Japanese Patent Application Laid-Open No. 7-168945. Thus, detail description of the calculation of the control point is omitted.

Next, in step S27, the control unit 11 calculates a straight line division number Nn of the division curve Cn based on the control points calculated in step S26, using a straight line approximation method. The straight line approximation method is conventionally known, for example, as discussed in Japanese Patent Application Laid-Open No. 11-58871. Thus, detail description of the calculation of the control point is omitted.

Next, in step S28, the control unit 11 performs calculation according to the above-described formulae (1) to (3) to obtain coordinate values of both endpoints of an i-th divided line segment Si (i=1, 2, . . . , Nn) of the division curve Cn.

Next, in step S29, the control unit 11 determines whether an incremented parameter (=present “i”+1) is equal to or greater than the straight line division number Nn of the division curve Cn. As a result of the above-described determination, if it is determined that the incremented parameter (=present “i”+1) is less than the straight line division number Nn of the division curve Cn (NO in step S29), the processing returns to step S28. The control unit 11 updates the present parameter “i” by the incremented parameter (=present “i”+1) and calculates coordinate values of both endpoints of the i-th divided line segment Si.

On the other hand, if it is determined that the incremented parameter (=present “i”+1) is equal to or greater than the straight line division number Nn of the division curve Cn (YES in step S29), namely, if the calculation of the coordinate values of both endpoints of each divided line segment Si of the division curve Cn is completed, the processing of the control unit 11 proceeds to step S30. When the processing proceeds to step S30, the control unit 11 determines whether an incremented endpoint number (=present endpoint number n+1) is equal to or greater than the division number Nc of the division curve Cn. As a result of the above-described determination, if it is determined that the incremented endpoint number (=present endpoint number n+1) is less than the division number Nc of the division curve Cn (NO in step S30), the processing returns to step S26. The control unit 11 updates present endpoint number n by the incremented endpoint number (=present endpoint number n+1), and executes the processing in step S26 with respect to the updated endpoint number n.

The control unit 11 repeats the above-described processing in steps S26 to S29 for each of Nc division curves. If the straight line division for the circular graphic pattern is completed, the processing of the control unit 11 proceeds to step S31 illustrated in FIG. 9.

In a case where the flowchart illustrated in FIG. 8 is executed, the control unit 11 determines that the radius r of the circular graphic pattern is large and there are numerous rasterization patterns for each divided line segment. Hence, in the present exemplary embodiment, if the processing illustrated in the flowchart in FIG. 8 is executed, the control unit 11 executes processing illustrated in the flowchart in FIG. 9 to perform rasterization processing according to the conventional method which is characterized in that calculation of coordinate values of each line segment on the display device is performed in units of a raster for each line segment.

When the processing proceeds to step S31 illustrated in FIG. 9, the control unit 11 sets a start point CPn as a processing raster position Ln for a line segment Sn (n=0, 1, . . . , N−1).

Next, in step S32, the control unit 11 calculates coordinate values of the line segment Sn at the processing raster position Ln on the display device. Subsequently, in step S33, the control unit 11 increments the present processing raster position Ln by 1 and shifts the present processing raster position to the next position (raster).

In step S34, the control unit 11 determines whether the present processing raster position Ln exceeds an end point NPn of the line segment Sn. As a result of the above-described determination, if it is determined that the present processing raster position Ln does not exceed the end point NPn of the line segment Sn (NO in step S34), the processing returns to step S32. The control unit 11 performs processing in step S32 with respect to the present processing raster position Ln. Then, if the present processing raster position Ln exceeds the end point NPn of the line segment Sn and the calculation of coordinate values of the end point NPn of the line segment Sn is completed (i.e., if the rasterization processing for the line segment Sn is completed), the processing of the control unit 11 proceeds to step S35.

When the processing proceeds to step S35, the control unit 11 determines whether an incremented endpoint number (=present endpoint number n+1) is equal to or greater than the straight line division number N of the circular graphic pattern (i.e., the drawing object). As a result of the above-described determination, if it is determined that the incremented endpoint number (=present endpoint number n+1) is less than the straight line division number N of the circular graphic pattern (i.e., the drawing object), the processing returns to step S31. The control unit 11 updates the present endpoint number n by the incremented endpoint number (=present endpoint number n+1), and executes the processing of step S31 with respect to the updated endpoint number n. The control unit 11 repetitively performs the above-described line segment rasterization processing in steps S31 to S34 for each of N line segments. If the rasterization processing for the circular graphic pattern is completed, the control unit 11 terminates the processing of the flowchart illustrated in FIG. 9.

As described above, in the present exemplary embodiment, the division number that defines the number of divided straight lines representing a circular graphic pattern is registered beforehand in the division number table TB1 in relation to the radius r of the circular graphic pattern. Further, the data D_x and D_y usable to calculate the X-coordinate and Y-coordinate values of the endpoints of respective divided straight lines are registered beforehand in the endpoint table TB2 in relation to the straight line division number N.

Accordingly, in a case where the graphic pattern to be drawn is a circular graphic pattern, it is not necessary to approximate an outline (curve) with Bezier curves and each division point (endpoint) of divided straight lines can be directly and quickly obtained. Further, the present exemplary embodiment can improve the efficiency in processing for calculating coordinate values of the endpoints of divided straight lines which is calculation processing requiring a large amount of processing load. Therefore, the present exemplary embodiment can quickly generate information relating to the endpoints of straight lines in a case where the drawing of a perfect circle is performed by dividing a peripheral portion of the perfect circle into a plurality of straight lines.

Further, in the present exemplary embodiment, information relating to rasterized data of a line segment is registered beforehand as a rasterization pattern in the rasterization pattern database DB in relation to a coordinate difference between both endpoints of the line segment. Accordingly, the present exemplary embodiment can draw a line segment without calculating coordinate values of an intersection point between the line segment and a raster (scan line) every time (for every scan line).

The processing in step S3 (FIG. 8) and step S6 (FIG. 9) illustrated in FIG. 5 according to the present exemplary embodiment is not limited to the above-described method and can be changed to any other conventional method capable of realizing the straight line division processing and the rasterization processing.

Further, in the present exemplary embodiment, the division number that defines the number of divided straight lines representing a circular graphic pattern is registered in the division number table TB1 in relation to the radius r of the circular graphic pattern. However, instead of using the radius r of the circular graphic pattern, it is useful to use any other size information, such as a diameter or a circumferential length, defining the circular graphic pattern (perfect circle).

Further, in the present exemplary embodiment, switching of the processing is performed based on a comparison result of the radius r of the circular graphic pattern to the maximum division radius Rd and the maximum rasterization radius Rr. However, the processing in step S13 and subsequent steps illustrated in FIG. 6 and the processing in step S20 and subsequent steps illustrated in FIG. 7 may be unconditionally executed without setting at least one of the maximum division radius Rd and the maximum rasterization radius Rr.

Further, the information processing apparatus 10 described in the present exemplary embodiment is an example of the image drawing apparatus according to the present invention. However, the image drawing apparatus according to the present invention can be a printing apparatus.

Next, a second exemplary embodiment according to the present invention is described below. The drawing described in the first exemplary embodiment is applied to a general circular graphic pattern (the whole). On the other hand, the drawing according to the present exemplary embodiment is performed in a case where an interpolated graphic pattern designated in line join processing or line cap processing is a circle. In this case, it is necessary to select only a required part of a circular graphic pattern to be drawn.

The present exemplary embodiment is mainly different from the above-described first exemplary embodiment in processing in which a graphic pattern to be subjected to the rasterization processing (processing for dividing a curved graphic pattern into a plurality of straight lines and calculating coordinate values of the endpoints of each divided straight line) is different. Accordingly, in the following description of the present exemplary embodiment, portions similar to those described in the first exemplary embodiment are denoted by the same reference numerals used in FIGS. 1 to 9 and their descriptions are not repeated.

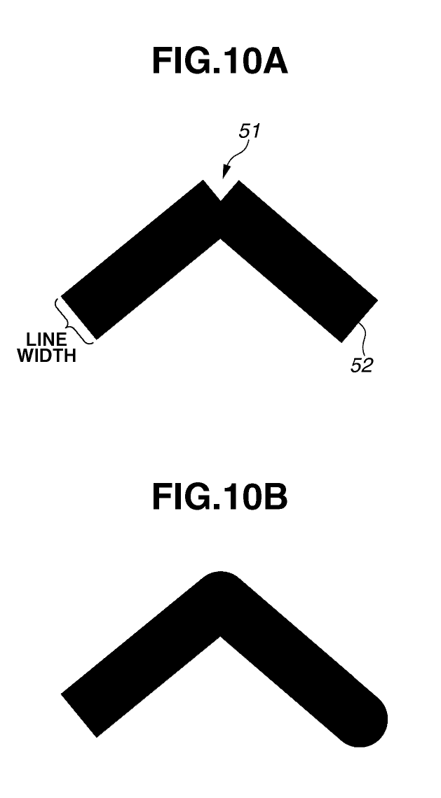

FIGS. 10A and 10B illustrate examples of the line join processing and the line cap processing.

As illustrated in FIG. 10A, a gap 51 may be generated at a broken line portion when a line having a significant line width is drawn. The line join processing can be performed to interpolate the above-described gap 51 with a predetermined shape, such as a straight line, a broken line, or a circle, as illustrated in FIG. 10B. Further, as illustrated in FIG. 10A, a line edge 52 may be formed when a line having a significant line width is drawn. The line cap processing can be performed to interpolate the line edge 52 with a predetermined shape, such as a straight line, or a circle, as illustrated in FIG. 10B.

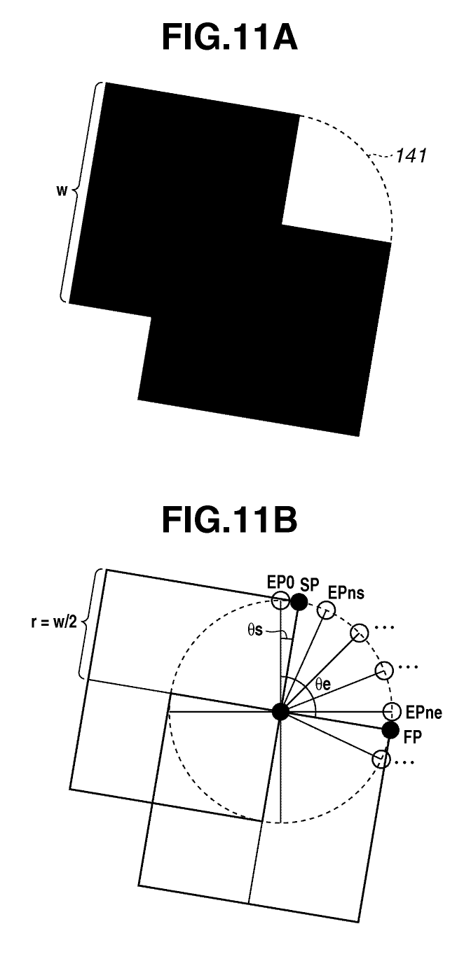

FIG. 11A illustrates an example of the broken line portion forming a gap. FIG. 11B illustrates an example of endpoints representing a circular graphic pattern to be used to interpolate the gap in the line join processing.

As illustrated in FIG. 11A, when drawing of a broken line having a line width w is performed by interpolating the gap with a circle according to the line join processing, it is necessary to interpolate the gap of the broken line with the circular graphic pattern indicated by a dotted line 141. In the following description, the above-described circular graphic pattern is referred to as an interpolated circular graphic pattern as necessary.

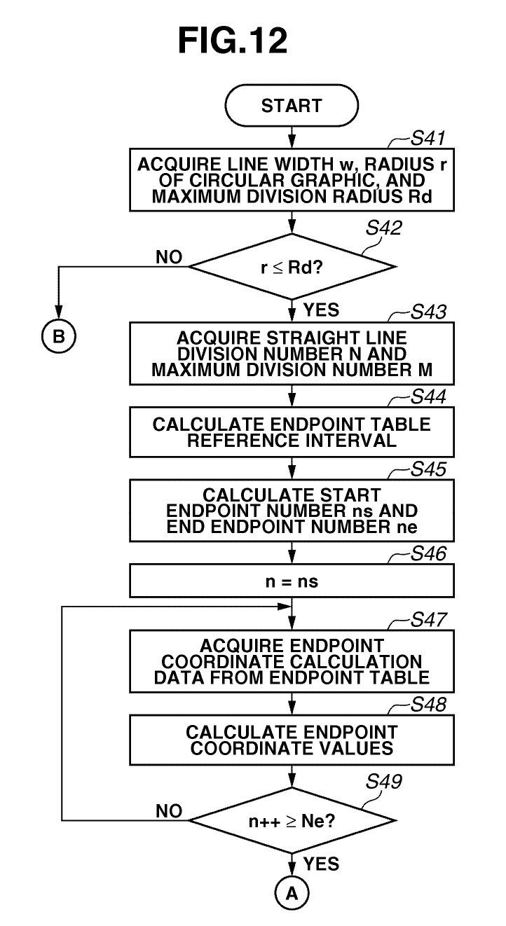

FIG. 12 is a flowchart illustrating an example of the straight line division processing which is replaceable with the flowchart illustrated in FIG. 6. In the present exemplary embodiment, similar to the first exemplary embodiment, setting of parameters is accomplished beforehand.

First, in step S41 illustrated in FIG. 12, the control unit 11 acquires a radius r of an interpolated circular graphic pattern and the maximum division radius Rd. In this case, the radius r of the interpolated circular graphic pattern in the line join processing or the line cap processing is equal to a half of the line width w of the line segment (broken line) to be drawn. First, the control unit 11 acquires the line width w and calculates the radius r of the interpolated circular graphic pattern as a length equivalent to a half of the acquired line width w.

Next, in step S42, the control unit 11 determines whether the radius r of the interpolated circular graphic pattern (i.e., the drawing object) is equal to or less than the maximum division radius Rd. As a result of the above-described determination, if it is determined that the radius r of the interpolated circular graphic pattern (i.e., the drawing object) is greater than the maximum division radius Rd (NO in step S42), the processing of the control unit 11 proceeds to step S25 illustrated in FIG. 8. Thus, the interpolated circular graphic pattern indicated by the dotted line 141 illustrated in FIG. 11A can be divided into straight lines according to the processing illustrated in FIG. 8.

On the other hand, if it is determined that the radius r of the interpolated circular graphic pattern (i.e., the drawing object) is equal to or less than the maximum division radius Rd (YES in step S42), the processing of the control unit 11 proceeds to step S43. When the processing proceeds to step S43, the control unit 11 directly acquires the straight line division number N for the interpolated circular graphic pattern (i.e., the drawing object) (one complete circle) from the division number table TB1 with reference to the radius r of the interpolated circular graphic pattern (i.e., the drawing object). Further, the control unit 11 acquires a maximum division number M.

As described above, an example of the first calculation unit according to the present exemplary embodiment can be realized, for example, by executing the processing in step S43. An example of the first storage area can be realized by using the division number table TB1.

Next, in step S44, the control unit 11 calculates a reference interval M/N that enables data reference corresponding to the desired straight line division number N based on the single endpoint table TB2 generated for the maximum division number M.

According to the example illustrated in FIGS. 11A and 11B, to interpolate the gap formed by the broken line illustrated in FIG. 11A with a circular graphic pattern, it is necessary to obtain endpoints EPns to EPne positioned between the angular points SP and FP of the broken line as illustrated in FIG. 11B.

Hence, in step S45, the control unit 11 calculates a start endpoint number ns and an end endpoint number ne of required endpoints.

As an example method, first, the control unit 11 obtains an angle θs [rad] between the reference point EP0 and the angular point SP and an angle θe [rad] between the reference point EP0 and the angular point FP. In this case, the angle θs is an angle defined between a straight line connecting the central point and the reference point EP0 and a straight line connecting the central point and the angular point SP. Further, the angle θe is an angle defined between a straight line connecting the central point and the reference point EP0 and a straight line connecting the central point and the angular point FP.

Next, the control unit 11 calculates the start endpoint number ns as an n satisfying a relationship (n−1)*2π/M<θs≦n*2π/M. Similarly, the control unit 11 calculates the end endpoint number ne as an n satisfying a relationship n*2π/M≦θe<(n+1)*2π/M. Thus, the endpoint numbers required in the drawing of the circular graphic pattern can be obtained. If the start endpoint number ns is obtained, then in step S46, the control unit 11 sets a start point of the endpoint coordinate calculation as n=ns.

Next, in step S47, the control unit 11 acquires data D_x and D_y that are usable to calculate coordinate values of a desired endpoint corresponding to the reference index n*M/N in the endpoint table TB2, based on the endpoint number n (n=ns, ns+1, . . . , ne) and the reference interval M/N.

In step S48, the control unit 11 performs calculation according to the above-described formulae (4) and (5) to obtain coordinate values (xn, yn) of the endpoint EPn based on the coordinate calculation data D_x and D_y acquired in step S47. In the present exemplary embodiment, the control unit 11 includes a unit configured to adapt coordinate calculation data of the endpoint table TB2 of a different quadrant to coordinate calculation data for the desired endpoint.

Next, in step S49, the control unit 11 determines whether an incremented endpoint number (=present endpoint number n+1) is equal to or greater than the end endpoint number ne. As a result of the above-described determination, if it is determined that the incremented endpoint number (=present endpoint number n+1) is less than the end endpoint number ne (NO in step S49), the processing returns to step S47. The control unit 11 updates the present endpoint number n by the incremented endpoint number (=present endpoint number n+1), and executes the processing in step S47 with reference to the updated endpoint number n.

If the above-described coordinate calculation for (ne−ns) endpoints is completed, the processing of the control unit 11 proceeds to step S18 illustrated in FIG. 7. Then, similar to the first exemplary embodiment, the control unit 11 performs rasterization processing to draw only a required portion of divided line segments (including line segments SP-Epns and EPne-FP) along an arc SP-FP, i.e., an interpolated graphic pattern.

As described above, an example of the second calculation unit according to the present exemplary embodiment can be realized, for example, by executing the processing in steps S44 to S49. Further, an example of the second storage area can be realized by using the endpoint table TB2.

As described above, the processing according to the present exemplary embodiment includes acquiring the straight line division number N from the division number table TB1 with respect to a circular graphic pattern having the radius r comparable to a half of the line width of a line in performing the line join processing or the line cap processing. The processing according to the present exemplary embodiment further includes obtaining the start endpoint number ns and the end endpoint number ne corresponding to an interpolated area (indicated by the dotted line 141), and calculating coordinate values of respective endpoints from the start endpoint number ns to the end endpoint number ne, based on the endpoint coordinate calculation data D_x and D_y acquired from the endpoint table TB2. Accordingly, the present exemplary embodiment can obtain effects similar to those obtained in the first exemplary embodiment not only in drawing an ordinary circular graphic pattern but also in using a circular graphic pattern in the line join processing or the line cap processing.

The above-described exemplary embodiments are mere examples capable of embodying the present invention. However, the present invention should not be narrowly interpreted based on only the above-described exemplary embodiments. In other words, the present invention can be embodied in various ways without departing from the scope or essential features of the present invention.

The present invention can be realized by executing the following processing. More specifically, software (program) capable of realizing functions of the above-described exemplary embodiments can be supplied to a system or an apparatus via a network or an appropriate storage medium. A computer (or CPU or micro-processing unit (MPU)) in the system or the apparatus can read and execute the program.

According to the exemplary embodiments of the present invention, information relating to a division number of a perfect circle, information relating to endpoint positions of straight lines, and information relating to rasterization patterns of the straight lines are registered in advance. Therefore, in a case where drawing of a perfect circle is performed by dividing a peripheral portion of the perfect circle into a plurality of straight lines, information relating to endpoints of the straight lines and rasterization data of the straight lines can be quickly generated. Further, according to the exemplary embodiments of the present invention, the efficiency in the processing can be improved by reducing an amount of information registered beforehand by taking the drawing of a perfect circle into consideration.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-234394 filed Oct. 8, 2009, which is hereby incorporated by reference herein in its entirety.

What is claimed is:

1. An apparatus which divides vector data representing a circle into a plurality of straight lines and rasterizes a part or a whole of the circle based on the divided plurality of straight lines, the apparatus comprising:
a first calculation unit configured to calculate a division number N of the circle referring to a first storage area in which information relating to the division number is registered in advance with respect to information relating to a size of the circle;
a second calculation unit configured to calculate endpoint positions of the plurality of straight lines by using the calculated division number referring to a second storage area in which information relating to the endpoint positions is registered in advance with respect to the information relating to the division number; and
a drawing unit configured to rasterize the circle by using a third calculation unit configured to calculate a rasterization pattern representing a drawing content of a finite number of straight lines having endpoints at the calculated positions referring to a third storage area in which information relating to the rasterization pattern representing the straight lines is registered in advance with respect to information relating to a relative positional relationship between both endpoints of the straight lines.

2. The apparatus according to claim 1, wherein
the information relating to the endpoint positions is registered in the second storage area with respect to information relating to predetermined M pieces of division number, and
the second calculation unit is configured to read registered information relating to the endpoint positions from the second storage area, at intervals of M/N, if a division number N is smaller than M.

3. The apparatus according to claim 1, wherein
information relating to endpoint positions corresponding to a part of the circle which are endpoint positions corresponding to the division number is registered in the second storage area, and
the second calculation unit is configured to calculate information relating to endpoint positions corresponding to another part of the circle which is not registered in the second storage area using the information registered in the second storage area.

4. The apparatus according to claim 1, wherein the first calculation unit is configured to calculate the division number if the size of the circle is smaller than a predetermined size.

5. The apparatus according to claim 1, wherein
information relating to the rasterization pattern representing the straight line corresponding to a part of the circle which is a rasterization pattern of the straight line corresponding to the relative positional relationship between both endpoints of the straight line is registered in the third storage area, and
the drawing unit is configured to calculate information relating to a rasterization pattern representing a straight line corresponding to another part of the circle which is not registered in the third storage area using the information registered in the third storage area.

6. The apparatus according to claim 1, wherein the third calculation unit is configured to calculate the rasterization pattern if the size of the circle is smaller than a predetermined size.

7. A method for drawing an image in which vector data representing a circle is divided into a plurality of straight lines and a part or a whole of the circle is rasterized based on the divided plurality of straight lines, the method comprising:
calculating a division number N of the circle referring to a first storage area in which information relating to the division number is registered in advance with respect to information relating to a size of the circle;
calculating endpoint positions of the plurality of straight lines by using the calculated division number referring to a second storage area in which information relating to the endpoint positions is registered in advance with respect to the information relating to the division number; and
rasterizing the circle by calculating a rasterization pattern representing a drawing content of a finite number of straight lines having endpoints at the calculated positions referring to a third storage area in which information relating to the rasterization pattern representing the straight lines is registered in advance with respect to information relating to a relative positional relationship between both endpoints of the straight lines.

8. The method according to claim 7, further comprising:
registering the information relating to the endpoint positions in the second storage area with respect to information relating to predetermined M pieces of division number; and
reading registered information relating to the endpoint positions from the second storage area, at intervals of M/N, if a division number N is smaller than M.

9. The method according to claim 7, further comprising:
registering information relating to endpoint positions corresponding to a part of the circle which are endpoint positions corresponding to the division number in the second storage area; and
calculating information relating to endpoint positions corresponding to another part of the circle which is not registered in the second storage area using the information registered in the second storage area.

10. The method according to claim 7, further comprising wherein calculating the division number if the size of the circle is smaller than a predetermined size.

11. The method according to claim 7, further comprising:
registering in the third storage area, information relating to the rasterization pattern representing the straight line corresponding to a part of the circle which is a rasterization pattern of the straight line corresponding to the relative positional relationship between both endpoints of the straight line; and
calculating information relating to a rasterization pattern representing a straight line corresponding to another part of the circle which is not registered in the third storage area using the information registered in the third storage area.

12. The method according to claim 7, further comprising calculating the rasterization pattern if the size of the circle is smaller than a predetermined size.

13. A computer-readable storage medium storing a program causing a computer to divide vector data representing a circle into a plurality of straight lines and rasterize a part or a whole of the circle based on the divided plurality of straight lines, the program comprising:
a computer-executable instruction for calculating a division number N of the circle referring to a first storage area in which information relating to the division number is registered in advance with respect to information relating to a size of the circle;
a computer-executable instruction for calculating endpoint positions of the plurality of straight lines by using the calculated division number referring to a second storage area in which information relating to the endpoint positions is registered in advance with respect to the information relating to the division number; and
a computer-executable instruction for rasterizing the circle by calculating a rasterization pattern representing a drawing content of a finite number of straight lines having endpoints at the calculated positions referring to a third storage area in which information relating to the rasterization pattern representing the straight lines is registered in advance with respect to information relating to a relative positional relationship between both endpoints of the straight lines.

14. The computer-readable storage medium according to claim 13, further comprising:
a computer-executable instruction for registering the information relating to the endpoint positions in the second storage area with respect to information relating to predetermined M pieces of division number; and
a computer-executable instruction for reading registered information relating to the endpoint positions from the second storage area, at intervals of M/N, if a division number N is smaller than M.

15. The computer-readable storage medium according to claim 13, further comprising:
a computer-executable instruction for registering information relating to endpoint positions corresponding to a part of the circle which are endpoint positions corresponding to the division number in the second storage area; and
a computer-executable instruction for calculating information relating to endpoint positions corresponding to another part of the circle which is not registered in the second storage area using the information registered in the second storage area.

16. The computer-readable storage medium according to claim 13, further comprising a computer-executable instruction for calculating the division number if the size of the circle is smaller than a predetermined size.

17. The computer-readable storage medium according to claim 13, further comprising:
a computer-executable instruction for registering in the third storage area, information relating to the rasterization pattern representing the straight line corresponding to a part of the circle which is a rasterization pattern of the straight line corresponding to the relative positional relationship between both endpoints of the straight line; and
a computer-executable instruction for calculating information relating to a rasterization pattern representing a straight line corresponding to another part of the circle which is not registered in the third storage area using the information registered in the third storage area.

18. The computer-readable storage medium according to claim 13, further comprising a computer-executable instruction for calculating the rasterization pattern if the size of the circle is smaller than a predetermined size.
